(19) United States
(12) Patent Application Publication
(10) Pub. No.: US 2019/0155049 A1
(43) Pub. Date: May 23, 2019

(54) Reversible Eyeglass Frame

(71) Applicant: Robert Watkains, Tampa, FL (US)

(72) Inventor: Robert Watkains, Tampa, FL (US)

(21) Appl. No.: 15/815,908

(22) Filed: Nov. 17, 2017

(51) Int. Cl. G02C 5/14; G02C 5/00

(52) U.S. Cl. CPC G02C 5/143; G02C 5/008; G02C 5/001

(57) ABSTRACT

A reversible eyeglass frame that can be flipped from a position over a user's eye to the back of the users head. When it is desirable or necessary for a user to remove their glasses, if the glasses use such reversible eyeglass frames, the user can simply flip the glasses to the back of their head stead of removing them. The glasses do not thereby become loose items, and are conveniently and securely retained on the back of the user's head.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

At least some embodiments disclosed herein relate, in general, to eyeglass frames and more specifically to reversible eyeglass frames.

### BACKGROUND

Many people wear eyeglasses and sunglasses for a variety of purposes. Oftentimes, it may be desirable or necessary to remove such glasses. The glasses then become loose items that can be inconvenient to carry around and are easily lost.

### BRIEF DESCRIPTION OF THE DRAWINGS

The embodiments are illustrated by way of example and not limitation in the figures of the accompanying drawings in which like references indicate similar elements.

FIG. 1A-B shows two perspective views of a reversible eyeglass frame.

FIG. 2A-C illustrates how the reversible eyeglass frame of FIG. 1 can be used by a user.

### SUMMARY

In an embodiment, the present disclosure relates to reversible eyeglass frames that can be flipped from a position over a user's eyes to the back of the users head.

In an embodiment, the reversible eyeglass frame comprises a right lens retaining portion and a left lens retaining portion connected by a bridge. A right arm is connected to the right side of the right lens retaining portion, the right arm having an upward facing ear hook and a downward facing ear hook. A left arm is connected to a left side of the left lens retaining portion, the left arm having an upward facing ear hook and a downward facing ear hook.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present disclosure is directed to reversible eyeglass frames that can be flipped from a position over a user's eye to the back of the users head. When it is desirable or necessary for a user to remove their glasses, if the glasses use such reversible eyeglass frames, the user can simply flip the glasses to the back of their head stead of removing them. The glasses do not thereby become loose items, and are conveniently and securely retained on the back of the user's head.

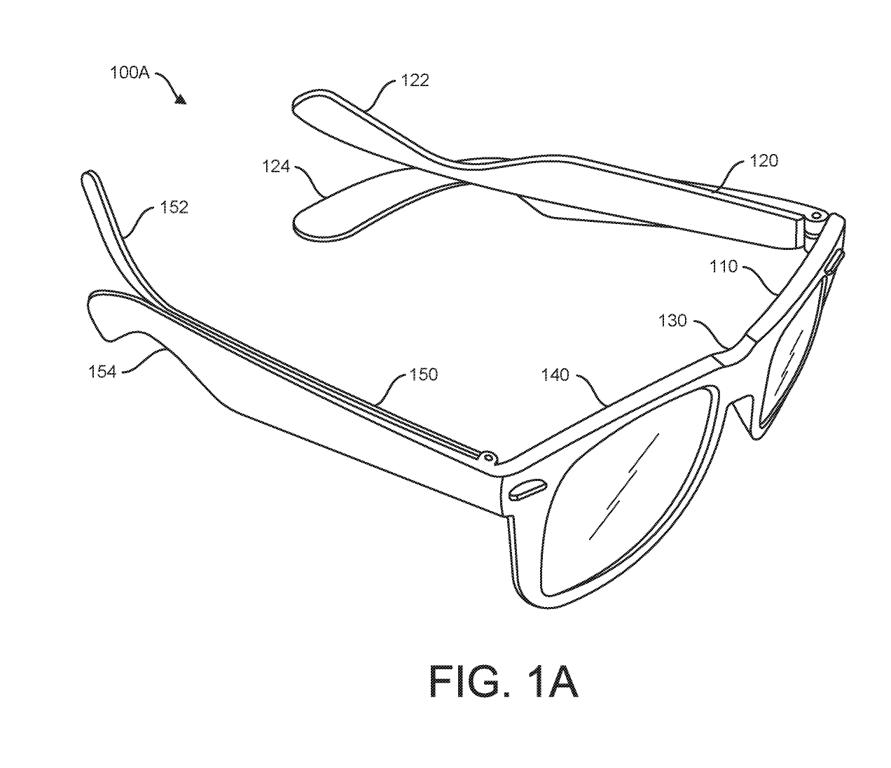

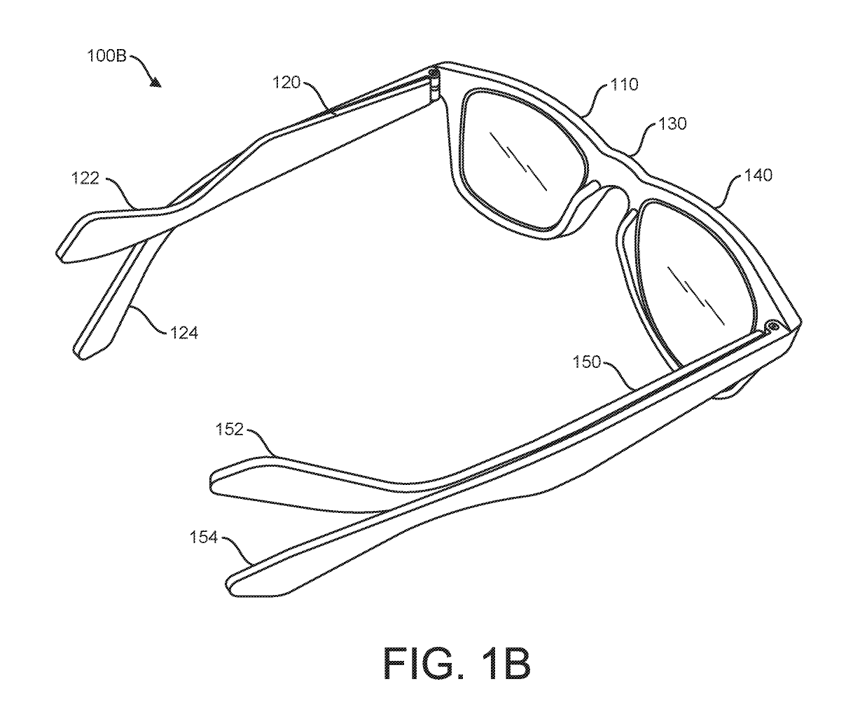

FIG. 1A-B shows two perspective views of an embodiment of a reversible eyeglass frame 100.

The illustrated embodiment of a reversible eyeglass frame has a right lens retaining portion 110 and a left lens retaining portion 140. In the illustrated embodiment, the lens retaining portions are roughly trapezoidal and comprise a frame entirely encircling a lens. It will be readily appreciated by those skilled in the art that other embodiments are possible. For example, the frame encircling the lens could be any shape, such as, for example, circular, oval, square, rectangular, and so forth.

It will also be readily appreciated that the lens retaining portions need not be a frame entirely encircling a lens. For example, the lens retaining portion could be configured to hold a lens only at the top of the lens. Other configurations could be designed to partially or completely hold a lens along one or both sides of the lens. Numerous other configurations are possible, as will be readily appreciated by those skilled in the art, and are intended to be within the scope of the disclosure.

In the illustrated embodiment, the right 110 and left 140 lens retaining portions are connected by a bridge 130. In the illustrated embodiment, the bridge 130 is a distinct bar that may, in some embodiments, rest on a user's nose. In other embodiments, the bridge 130 may simply be a point where the right 110 and left 140 lens retaining portions are fused. Numerous other configurations are possible, as will be readily appreciated by those skilled in the art, and are intended to be within the scope of the disclosure.

In various embodiments, the right 110 and left 140 lens retaining portions can be used to retain any type of lens such as, for example, sunglass lens, reading glass lens, prescription glass lens, safety glass lens, and any other type of lens now known or later developed in the art.

in the illustrated embodiment, the right lens retaining portion 110 has a right arm 120 connected to the right side of the right lens retaining portion 110. The right arm 120 has an upward facing ear hook 122 and a downward facing ear hook 124. The downward facing ear hook 124 grips a user's ear when the eyeglass frame is worn on the user's face, and the upward facing ear hook 122 grips a user's ear when the eyeglass frame is worn on the back of the user's head, The shape of the ear hooks 122 and 124 is not limited to the shape shown in FIG. 1A-B, but rather any shape now known or later to be developed in the art is adapted to grip a user's ear is intended to be within the scope of the disclosure.

In the illustrated embodiment, the left lens retaining portion 140 has a left arm 150 connected to the left side of the right lens retaining portion 140. The right arm 150 has an upward facing ear hook 152 and a downward facing ear hook 154. The downward facing ear hook 154 grips a user's ear when the eyeglass frame is worn on the user's face, and the upward facing ear hook 152 grips a user's ear when the eyeglass frame is worn on the back of the user's head. The shape of the ear hooks 152 and 154 is not limited to the shape shown in FIG. 1A-B, but rather any shape now known or later to be developed in the art is adapted to grip a user's ear is intended to be within the scope of the disclosure.

In the illustrated embodiment, the right arm 120 and the left arm 150 are connected to the right lens retaining portion 110 and the left lens retaining portions 140, respectively, by hinges. However, the arms 120 and 150 can be connected to the lens retaining portions 110 and 140 by any suitable means. For example, the entire reversible eyeglass frame could be fabricated as a single piece of material. Numerous other configurations are possible, as will be readily appreciated by those skilled in the art, and are intended to be within the scope of the disclosure.

In the illustrated embodiment, the right arm 120 and the left arm 150 are fabricated by fusing one arm with an upward facing ear hook with another arm with a downward facing ear hook. In other embodiments, the right arm 120 and the left arm 150 could be fabricated as a single piece of material.

The reversible eyeglass frame 100 could be fabricated from any suitable material, for example, plastic, horn, composite material, wood, or metal, or any other material now known or later to be developed in the art that can be adapted for use in fabricating eyeglass frames.

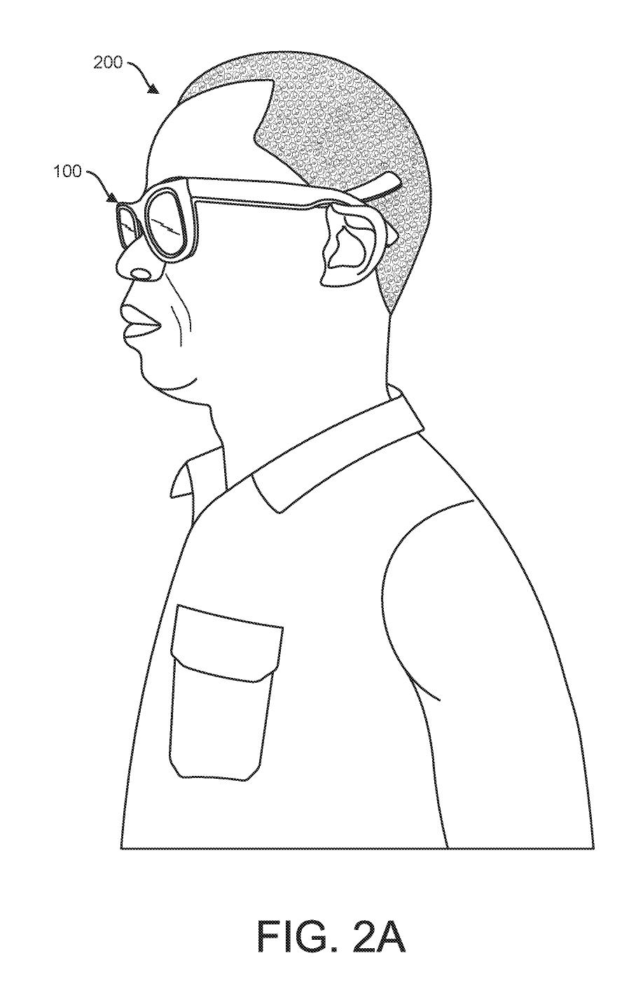

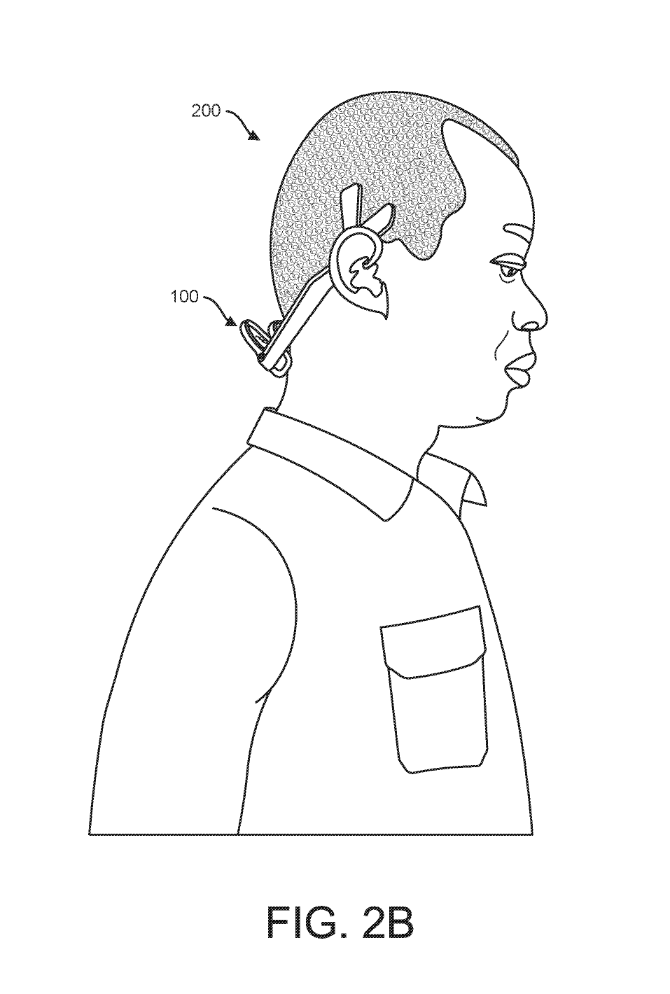

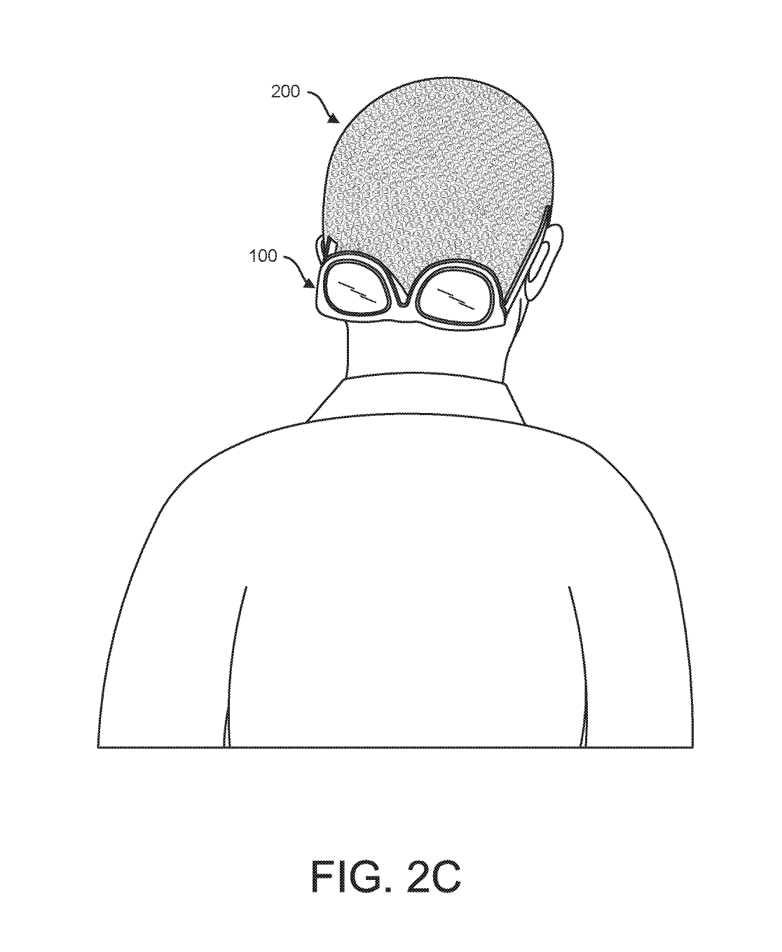

FIG. 2A-C illustrates how the reversible eyeglass frame of FIG. 1 can be used by a user 200.

FIG. 2A shows a user 200 wearing a pair of glasses 100 using a reversible eyeglass frame. The downward facing ear hooks grip the user's ears. The user can then flip the glasses 100 over his or her head (not shown) and wear the glasses on the back of his or her head, as shown in FIG. 2B-C.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A reversible eyeglass frame, comprising:
a right lens retaining portion;
a left lens retaining portion;
a bridge connecting the right lens retaining portion and the left lens retaining portion;
a right arm connected to a right side of the right lens retaining portion, the right arm having an upward facing ear hook and a downward facing ear hook;
a left arm connected to a left side of the left lens retaining portion, the left arm having an upward facing ear hook and a downward facing ear hook.

2. The reversible eyeglass frame of claim 1 wherein
the right lens retaining portion and the left lens retaining portion each comprise a frame entirely encircling a lens.

3. The reversible eyeglass frame of claim 2 wherein
the shape of the right lens retaining portion and the left lens retaining portion is one of trapezoidal, circular, oval, square, rectangular.

4. The reversible eyeglass frame of claim 1 wherein
the right lens retaining portion and the left lens retaining portion each hold a lens only at the top of the lens.

5. The reversible eyeglass frame of claim 1 wherein
the bridge is approximately bar shaped.

6. The reversible eyeglass frame of claim 1 wherein
the bridge represents a point where the right lens retaining portion and the a left lens retaining portion are fused.

7. The reversible eyeglass frame of claim 1 wherein
the right arm and the left arm are connected to the right lens retaining portion and the left lens retaining portions, respectively, by hinges.

8. The reversible eyeglass frame of claim 1 wherein
the reversible eyeglass frame is fabricated as a single piece of material.

9. The reversible eyeglass frame of claim 1 wherein
the right arm and the left arm are each fabricated by fusing one arm with an upward facing ear hook with another arm with a downward facing ear hook.

10. The reversible eyeglass frame of claim 1 wherein
the reversible eyeglass frame is fabricated from one of plastic, horn, composite material, wood, or metal.

11. The reversible eyeglass frame of claim 1 wherein
the right and left lens retaining portions are used to retain lenses that are one of sunglass lenses, reading glass lenses, prescription glass lenses, safety glass lenses.
